(19) United States
(12) Patent Application Publication
(10) Pub. No.: US 2015/0126104 A1
(43) Pub. Date: May 7, 2015

(54) AIR BLOWER DEVICE

(71) Applicant: HOWA PLASTICS CO., LTD., Toyota-Shi (JP)

(72) Inventor: Hiroyuki Ooes, Toyota-Shi (JP)

(21) Appl. No.: 14/376,001

(22) PCT Filed: Jan. 25, 2013
(86) PCT No.: PCT/JP2013/051583

§ 371 Date: Jan. 21, 2015

(30) Foreign Application Priority Data
Feb. 1, 2012 (JP) 2012-019870

(51) Int. Cl. F15D 1/08; B60H 1/34

(52) U.S. Cl. CPC F15D 1/08; B60H 1/34
USPC 454/254

(57) ABSTRACT

An air outlet apparatus defines: an air guide channel to pass through an airflow; and an air outlet to blow out the airflow passed through the air guide channel. The air outlet apparatus has a configuration: to guide a plurality of the airflows from a plurality of directions toward a collision area, the collision area being an area to allow the airflows to be collided with each other and at least part of the collision area being in the air guide channel; and to control an blowing air from the air outlet through the air guide channel in at least one of flow direction or convergence degree by controlling strengths of the airflows guided to the collision area.

### TECHNICAL FIELD

This invention relates to air outlet apparatuses for vehicles such as automobiles.

### BACKGROUND ART

Air outlet apparatuses, which regulate flow rate and flow direction of heating and cooling air, have conventionally been used to control indoor environments of vehicles such as automobiles. A conventional air outlet apparatus (here in after referred to as “conventional apparatus”), for example, has a hollow tubular body defining an air guide channel (a flow passage) and a plurality of air guide plates rotatably supported in the tubular body. This conventional apparatus enables its blowing air to be regulated in flow rate and flow direction by adjusting rotational positions (i.e., rotational angles around an axis perpendicular to the center axis of the tubular body) of the air guide plates (see the patent literature, JP 2011-079374 A, in Citation List).

### CITATION LIST

### Patent Literature

JP 2011-079374 A

### SUMMARY OF INVENTION

### Technical Problem

For air outlet apparatuses used in automobiles, an air outlet apparatus is typically located in an area around a dashboard of an automobile. In recent years, however, the area to locate the air outlet apparatus has been reducing its space to enhance an appearance of and around the dashboard. This causes the air outlet apparatus to be desired to further reduce its size as far as possible without limiting its own functions.

However, the conventional apparatus is configured to regulate its blowing air in flow rate and flow direction by using the air guide plates, as described above. This configuration typically makes it difficult to reduce the entire size of the conventional apparatus without limiting its functions (i.e., the regulation in flow rate and flow direction). For example, any careless downsizing of the conventional apparatus can also downsize the air guide plates, thus reducing an amount of air to be regulated by the air guide plates. This can cause the conventional apparatus to fail to sufficiently regulate its blowing air in flow direction. On the other hand, for example, any downsizing of the conventional apparatus while keeping the size of the air guide plates can relatively enlarge the air guide plates compared with the air guide channel, thus reducing an amount of air to pass through the conventional apparatus. This can cause the conventional apparatus to fail to sufficiently ensure an amount of its blowing air.

It is an object of the present invention to provide an air outlet apparatus that enables reducing its size without limiting its own function(s).

### Solution to Problem

An air outlet apparatus, to achieve the above object, comprises: an air guide channel to pass through an airflow; and an air outlet to blow out the airflow passed through the air guide channel.

The air outlet apparatus may have any configuration to define the air guide channel and the air outlet, and its specific configuration is not limited. For example, the air outlet apparatus may have a body to define the air guide channel (in other words, an area or a region to allow airflow to be passed through its inside) and to allow the airflow passed through the channel to blow out from an opening (i.e., the air outlet) formed on the body. In addition, the air outlet in this body corresponds to an open end of the air guide channel (see the embodiment F described below).

The air guide channel of the air outlet apparatus is not perpendicularly limited in its number and its configuration. For example, the air outlet apparatus of the present invention may define one or more air guide channels. Furthermore, for example, a plurality of individual air guide channels may combine each other and form singular air guide channel, and then the entire air guide channel(s) may form one air guide channel.

This air outlet apparatus has a configuration:

to guide a plurality of the airflows from a plurality of directions toward a collision area, which is an area to allow the airflows to be collided with each other, and at least part of which is in the air guide channel; and

to control an blowing air from the air outlet through the air guide channel in at least one of flow direction or convergence degree by controlling strengths of the airflows guided to the collision area.

Due to the above configuration, controlling the strengths of one or more of the airflows guided to the collision area enables the air outlet apparatus to control at least one of flow direction or convergence degree of an airflow blown out from the air outlet (here in after referred to as “blowing air”). Hence, the air outlet apparatus according to the present invention enables controlling its blowing air without using the air guide plates of the conventional apparatus. This thus enables providing an air outlet apparatus that enables reducing its size without limiting its own function(s).

Furthermore, in the air outlet apparatus according to the present invention, locating at least part of the collision area in the air guide channel enables the air outlet apparatus to reduce or eliminate diffusing of the airflows collided in the collision area to the outside of the collision area (in other words, to any direction different from the direction toward the air outlet). The air outlet apparatus according to the present invention thus enables forming a blowing air more efficiently compared with locating the whole of the collision area outside of the air guide channel.

Furthermore, in the air outlet apparatus according to the present invention, eliminating the air guide plates required and employed in the conventional apparatus enables the air outlet apparatus to design the shape of the air outlet more freely compared with the conventional apparatus (since, for example, the air outlet apparatus does not require any effort in designing the air guide plates in its location, size and rotational range). For example, the shape of the air outlet may include several shapes in view of a beautiful appearance (such as rectangle, ellipse, triangle, rhombus, and any shape formed by combining them).

The “at least one of flow direction or convergence degree of the blowing air” is here in after referred to as “state of the blowing air” for the sake of simplicity. In addition, as can be understood from the above, the air outlet apparatus enables controlling the “flow rate” as well by controlling the strengths of the airflows guided to the collision area. Furthermore, eliminating the air guide plates enables the air outlet apparatus to enhance its appearance. Additionally, reducing the number of components to produce the air outlet apparatus enables the air outlet apparatus to reduce the cost for its production.

On the other hand, the term “in the air guide channel” represents “inner area or region of the air guide channel”. In other words, the term represents an area or a region upstream of the aperture surface defined by the air outlet. In addition, the “upstream” represents an opposite direction to the direction of air movement when air moves through the air guide channel.

The term “strength of the airflow” represents a parameter that can affect at least one of flow direction or convergence degree of the blowing air, and its specific parameter is not limited. For example, the strength of the airflow includes one or both of the flow rate (mass flow rate or volumetric flow rate) and the flow velocity of the airflow, a parameter determined based on one or both of them to represent a degree of the strength of the airflow, and an amount of energy that the airflow has.

The term “controlling strength of the airflow” includes increasing the strength of the airflow, decreasing the strength of the airflow, and keeping the strength of the airflow at a target strength. The “target strength” of course includes zero. In other words, one or more of a plurality of airflows (from a plurality of directions) guided to the collision area may have the strength of zero. For example, when the air outlet apparatus sets one airflow to have a specific strength other than zero and the other airflows to have zero strength (in other words, only one airflow is guided to the collision area), the one airflow passes through the collision area without changing its state such as flow direction due to no collision with the other airflows, and then going out from the air outlet.

The term “convergence degree” of the blowing air represents the degree of diffusing (or spreading) of the blowing air. Furthermore, methods to measure the convergence degree in numerical terms include, for example, a method to use a cross-sectional area of the blowing air at a location away from the air outlet apparatus by a predetermined distance when being cut by a plane perpendicular to the its flow direction, or a method to use a space angle defined by the blowing air when being assumed to have a cone-shape with a vertex that is a suitable single point in the collision area.

The degree of diffusing at a location away from the air outlet increases by decreasing convergence degree of the blowing air. This enables the blowing air to be soft (mild). On the other hand, the degree of diffusing at a location away from the air outlet decreases by increasing convergence degree of the blowing air. This enables the blowing air to be hard (sharp).

In addition, as can be understood from the above, increasing the convergence degree of the blowing air means enhancing directivity of the blowing air. Thus, increasing the convergence degree of the blowing air to a target direction means ejecting the blowing air to the target direction intensively (in other words, aligning the flow direction of the blowing air with the target direction). Hence, controlling the convergence degree of the blowing air correlates controlling the flow direction of the blowing air.

Next, several embodiments (the embodiment A to the embodiment F) of the air outlet apparatus according to the present invention will be described below.

### Embodiment A

The air outlet apparatus according to the present invention is not limited in its method or configuration to guide the airflows toward the collecting region.

For example, the air outlet apparatus according to the present invention may further comprise a regulation member to regulate flow directions of the airflows guided to the collision area.

The above configuration enables the airflows “before” entering the collision area (in other words, before reaching to the collision area) to have an appropriate state in view of controlling the state of the blowing air (for example, to prevent its excessive diffusing). Hence, this air outlet apparatus enables the state of the blowing air to be controlled more accurately compared with an air outlet apparatus with no regulation member.

### Embodiment B

The regulation member described above is not limited in its configuration or shape.

For example, the air outlet apparatus according to the present invention may employ, as the regulation member, a member having a convex shape protruded to the collision area or a member having a shape to allow the airflows guided to the collision area to be converged.

As the “member having a convex shape”, a semicircular column member, a hemisphere (dome-like) member and a cone-like (cone or pyramid shape) member may be employed. This configuration allows the airflow “before” entering the collision area to be guided to flow along the surface of the member having a convex shape toward the collision area. Hence, determining the shape of this member (for example, its specific convex shape, size or radius of curvature of the convex surface) enables the airflow “before” entering the collision area to have an appropriate state in view of controlling the state of the blowing air (for example, to prevent its diffusing and to flow toward a target direction). In addition, this member may be placed upstream of the aperture surface of the air outlet to protrude to a direction from the upstream to the downstream of the airflow (in other words, to protrude toward the collision area).

As the “member having a shape to allow the airflows guided to the collision area to be converged”, a tubular member that enables an airflow to be ejected to a target direction and is placed to direct its axis to pass through the collision area may be employed. This configuration allows the airflow “before” entering the collision area to be converged to a target direction (in other words, to be guided to the collision area in a converged state to a target direction). Hence, determining the shape of this member (for example, its target direction to converge the airflow) enables the airflow “before” entering the collision area to have an appropriate state in view of controlling the state of the blowing air.

Controlling the state of the airflow “before” entering the collision area as described above enables the state of the airflow “after” the collision in the collision area (i.e., the blowing air) to be more appropriately controlled compared with a blowing air without such controlling. For example, that enables the blowing air to reduce or eliminate its diffusing to the outside of the collision area (in other words, to any direction different from the direction toward the air outlet) after the collision, thus enabling forming a blowing air more efficiently.

In addition, in view of the controlling of the state of the airflow before and after the collision, a front edge of the convex-shaped member may preferably be close to the collision area as far as possible (or touch to or enter the collision area). Furthermore, the member having a shape to allow the airflows to be converged may preferably achieve high convergence degree as far as possible.

### Embodiment C

The number of airflows to be guided to the collision area may be determined in view of performances of the apparatus such as a range of the flow direction of the blowing air and an accuracy of the controlling in flow direction and convergence degree, and its specific number is not limited.

For example, the air outlet apparatus according to the present invention may have a configuration to allow the airflows to be guided toward the collision area from at least three directions whose all or a part are arranged on separate planes different from each other.

When only two airflows are guided toward the collision area from two directions, the apparatus enables the blowing air to change its flow direction and convergence degree only in a plane (two dimensions) determined by the two directions. To the contrary, when at least three airflows are guided toward the collision area from at least three directions (which are not arranged on the same plane), the apparatus enables the blowing air to change its flow direction and convergence degree in an area (three dimensions) determined by the three directions. Hence, the above configuration enables the blowing air to control its state more freely compared with a configuration in which two airflows are guided to the collision area from two directions.

The term “at least three directions are arranged on separate planes different from each other” means eliminating an arrangement in which all of the at least three directions is on the same plane. In other words, the term includes: an arrangement in which each of the at least three directions is on its individual plane; and an arrangement in which one or more of the directions is on a plane while the other directions are the other plane.

### Embodiment D

Furthermore, the air outlet apparatus according to the present invention may have a configuration to allow the airflows to be guided toward the collision area from four directions whose all or a part are arranged on separate planes different from each other.

When the air outlet apparatus is mounted on vehicle equipment such as a dashboard of an automobile, the blowing air may preferably have four-degree-of-freedom of the flow direction (for example, upward direction, downward direction, right direction and left direction with respect to the central axis of the air outlet apparatus). The above configuration enables four airflows to be guided to the collision area from four directions, which correspond to the degree of freedom, and thus enabling a relatively easy controlling of the state of the blowing air.

The term “four directions are arranged on separate planes different from each other” means, as same as the above, eliminating an arrangement in which all of the four directions is on the same plane.

### Embodiment E

The strength of the airflow guided to the collision area may be controlled by an appropriate method, and its specific method is not limited.

For example, the air outlet apparatus according to the present invention may comprise a valve in the air guide channel to control an amount of the airflow passed through the air guide channel, and the strength of the airflow guided to the collision area after passing through the air guide channel may be controlled by changing an opening degree of the valve.

The above configuration enables a relatively easy controlling of the strength of the airflow guided to the collision area. In addition, when the air outlet apparatus defines a plurality of the air guide channels, each of the air guide channels may preferably have its individual valve. This enables the strengths of the airflows guided to the collision area to be controlled separately.

### Embodiment F

As can be understood from the above, the air outlet apparatus according to the present invention, which comprises the above characteristics (for example, guiding a plurality of airflows to the collision area from a plurality of directions, and controlling the strength of the airflow guided to the collision area) achieves the above object. In other words, the air outlet apparatus according to the present invention may comprise the above characteristics, and their specific configurations are not limited.

For example, as one specific configuration, the air outlet apparatus according to the present invention may comprise a body including: an air guide channel having a plurality of air passages and a collecting region to collect the air passages; an air outlet to blow out air passed through the air guide channel; and an air inlet to allow air to flow into the air guide channel,

the air passages each having a first open end near the air outlet and a second open end near the air inlet,

the first open ends each opening toward a collision area to locate at least part of the collision area in the air guide channel, the collision area being an area to allow airflows ejected from the first open ends to be collided with each other,

the air passages each having a control member to control a strength of the airflow to be guided toward the collision area.

Due to the above configuration, controlling the strengths of the airflows guided to the collision area by using the control member enables the air outlet apparatus to control at least one of flow direction or convergence degree of an airflow blown out from the air outlet (i.e., the state of the blowing air).

Furthermore, as same as the Embodiment A, the above air outlet apparatus may further comprise a regulation member to regulate the flow directions of the airflows guided to the collision area.

Furthermore, as same as the Embodiment B, the above air outlet apparatus may employ, as the regulation member, a member having a convex shape protruded to the collision area or a member having a shape to allow the airflows guided to the collision area to be converged.

Furthermore, as same as the Embodiment C, the above air outlet apparatus may have the first open ends each opening toward the collision area to allow the airflows to be ejected toward the collision area from at least three directions whose all or a part are arranged on separate planes different from each other.

Furthermore, as same as the Embodiment D, the above air outlet apparatus may have the first open ends each opening toward the collision area to allow the airflows to be ejected toward the collision area from four directions whose all or a part are arranged on separate planes different from each other.

Furthermore, as same as the Embodiment E, the above air outlet apparatus may employ, as the control member, a valve to control an amount of the airflow passed through the air guide channel.

The above configuration enables controlling of the strength of the airflow guided to the collision area by changing the opening degree of the valve.

### Advantageous Effects of Invention

As described above, the air outlet apparatus according to the present invention enables reducing its size without limiting its own function(s)

### BRIEF DESCRIPTION OF DRAWINGS

FIG. 1 is a schematic perspective drawing illustrating an air outlet apparatus, viewed from its front, according to an embodiment of the present invention.

FIG. 2 is a schematic perspective drawing illustrating an air outlet apparatus, viewed from its back, according to an embodiment of the present invention.

FIG. 3 is a schematic perspective drawing illustrating an air outlet apparatus, with its internal structure, according to an embodiment of the present invention.

FIG. 4 is an X-X cross-sectional drawing of the air outlet apparatus illustrated in FIG. 3

FIG. 5 is a schematic drawing illustrating relationships between airflows guided into an area to allow the airflows to be collided with each other and a blowing airflow resulted from the collision.

FIG. 6 is a schematic drawing illustrating relationships between airflows guided into an area to allow the airflows to be collided with each other and a blowing airflow resulted from the collision.

FIG. 7 is a schematic drawing illustrating relationships between airflows guided into an area to allow the airflows to be collided with each other and a blowing airflow resulted from the collision.

FIG. 8 is a schematic drawing illustrating relationships between airflows guided into an area to allow the airflows to be collided with each other and a blowing airflow resulted from the collision.

FIG. 9 is a schematic drawing illustrating relationships between airflows guided into an area to allow the airflows to be collided with each other and a blowing airflow resulted from the collision.

FIG. 10 is a schematic drawing illustrating relationships between airflows guided into an area to allow the airflows to be collided with each other and a blowing airflow resulted from the collision.

FIG. 11 is a schematic drawing illustrating relationships between airflows guided into an area to allow the airflows to be collided with each other and a blowing airflow resulted from the collision.

FIG. 12 is a schematic drawing illustrating relationships between airflows guided into an area to allow the airflows to be collided with each other and a blowing airflow resulted from the collision.

FIG. 13 is a schematic drawing illustrating relationships between airflows guided into an area to allow the airflows to be collided with each other and a blowing airflow resulted from the collision.

FIG. 14 is a schematic drawing illustrating relationships between airflows guided into an area to allow the airflows to be collided with each other and a blowing airflow resulted from the collision.

FIG. 15 is a schematic drawing illustrating relationships between airflows guided into an area to allow the airflows to be collided with each other and a blowing airflow resulted from the collision.

FIG. 16 is a schematic drawing illustrating relationships between airflows guided into an area to allow the airflows to be collided with each other and a blowing airflow resulted from the collision.

FIG. 17 is a schematic drawing illustrating relationships between airflows guided into an area to allow the airflows to be collided with each other and a blowing airflow resulted from the collision.

FIG. 18 is a schematic drawing illustrating relationships between airflows guided into an area to allow the airflows to be collided with each other and a blowing airflow resulted from the collision.

FIG. 19 is a schematic drawing illustrating relationships between airflows guided into an area to allow the airflows to be collided with each other and a blowing airflow resulted from the collision.

FIG. 20A is a schematic drawing illustrating several embodiments of a regulation member.

FIG. 20B is a schematic drawing illustrating several embodiments of a regulation member.

FIG. 21A is a schematic drawing illustrating several embodiments of an air outlet.

FIG. 21B is a schematic drawing illustrating several embodiments of an air outlet.

FIG. 22 is a schematic drawing illustrating several embodiments of the area to allow airflows to be collided with each other.

FIG. 23 is a schematic drawing illustrating an example of numbers of airflows guided to the area to allow the airflows to be collided with each other.

FIG. 24 is a schematic drawing illustrating an example of numbers of airflows guided to the area to allow the airflows to be collided with each other.

FIG. 25 is a schematic drawing illustrating an air outlet apparatus according to another embodiment of the present invention.

FIG. 26 is a schematic drawing illustrating an air outlet apparatus according to still another embodiment of the present invention.

### DESCRIPTION OF EMBODIMENTS

An air outlet apparatus according to an embodiment of the present invention will be described by referring to the drawings.

### (Apparatus Configuration)

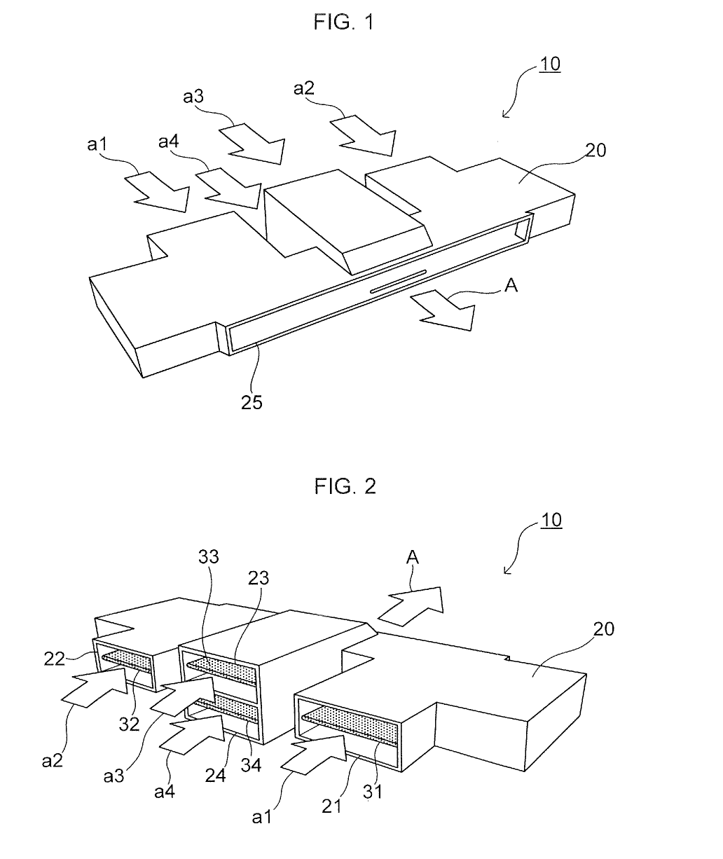

FIG. 1 to FIG. 3 are schematic drawings each illustrating an air outlet apparatus according to an embodiment of the present invention (here in after referred to as “apparatus embodiment”). The apparatus embodiment 10 includes a body 20 defining a plurality of air guide channels and control valves 31, 32, 33, 34 each located in the corresponding one of the air guide channels. These members will be described in detail below.

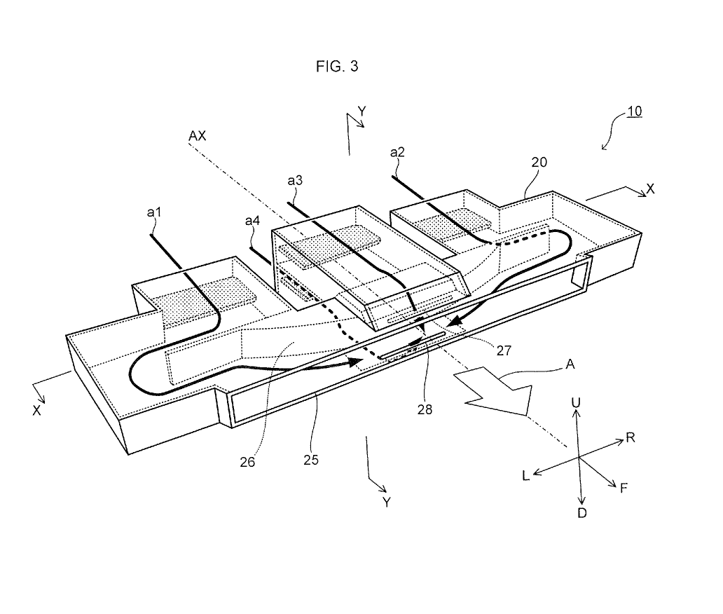

FIG. 1 is a schematic perspective drawing of the apparatus embodiment 10 when it is viewed from its front. FIG. 2 is a schematic perspective drawing of the apparatus embodiment 10 when it is viewed from its back. As illustrated in FIG. 1 and FIG. 2, the outline of the body 20 of the apparatus embodiment 10 is approximately a cuboid-like shape (a platy shape) that is longer in the width direction (width in the figure) than in height direction (height in the figure).

The body 20 has back-side inlets (here in after referred to as “air inlets”) 21, 22, 23, 24 to allow air to flow into the body 20 and a front-side outlet (here in after referred to as “air outlet”) 25 to allow the intake air to be blown out from the body 20. In other words, the body 20 defines the air guide channels in its inside to allow airflows a1, a2, a3, a4 flowed from the air inlets 21, 22, 23, 24 to pass through the channels (the air guide channels will be described in detail below). The body 20 blows out a blowing air A, which is a merged airflow of the airflows a1, a2, a3, a4 passed through the air guide channels, from the air outlet 25 to a target direction.

The control valves 31, 32, 33, 34 is supported in the body 20 (i.e., in the air guide channels) so that each of them is located near the corresponding one of the back-side inlets 21, 22, 23, 24. The control valves 31, 32, 33, 34 are valving elements each having a platy shape rotatable around a shaft to enable the corresponding one of the air guide channels to control an amount of air passed through the channel depending on its opening degree (i.e., its rotational angle). In other words, controlling the opening degrees of the control valves 31, 32, 33, 34 allow the airflows passing through the air guide channels toward the air outlet 25 to change their strengths (for example, their flow rates). The control valves 31, 32, 33, 34 are configured to enable their opening degrees to be controlled by using usual methods (for example, a method to allow users to directly control the control valves via linking members (not illustrated), or a method to operate motors (not illustrated) mounted on the control valves depending on user's instructions).

The air guide channels defined by the body 20 will be described in detail below. FIG. 3 is a schematic drawing illustrating the body 20 with its internal structure to explain the air guide channels. As illustrated in FIG. 3, the body 20 has, in its inside, several members illustrated by broken lines. Those members define: four air passages (a plurality of air passages) to allow the airflows a1, a2, a3, a4 to pass through the four passages; and a collecting region to allow the air passages to be collected (which corresponds to, in FIG. 3, an area in the air guide channels near the center of the air outlet 25). In other words, the body 20 has the air guide channels that form the four (a plurality of) air passages and the collecting region for the passages.

The dashed-dotted line AX in the figure is here in after referred to as “central axis AX of the body 20” for the sake of simplicity. Furthermore, the direction toward an area in front of the body 20 along the central axis AX is here in after referred to as “front direction (F)”, the direction toward an upper area over the body 20 perpendicular to the central axis AX as “upward direction (U)”, the direction toward a downward area below the body 20 perpendicular to the central axis AX as “downward direction (D)”, the direction toward a right area beside the body 20 perpendicular to the central axis AX as “right direction (R)”, and the direction toward a left area beside the body 20 perpendicular to the central axis AX as “left direction (L)”. These directions are defined according to the up, down, left and right directions when the apparatus embodiment 10 is actually mounted on vehicle equipment such as a dashboard of an automobile and viewed by users.

When the airflow a1 flows into the body 20, the airflow a1 once changes its flow direction to the left direction (L) to be directed away from the central axis AX of the body 20, and then changes its flow direction to be directed close to the central axis AX again. After that, the airflow a1 moves along a frontal surface of a regulation member 26 in the front direction (F), which member has a convex shape protruded to the front direction (F), and flows to the center of the air outlet 25 (i.e., the collecting region). The regulation member 26 regulates (or controls or restricts) the flow direction of the airflow a1 as above. The airflow a1 flows to a direction slightly leaned toward the front direction (F) compared with a direction perpendicular to the central axis AX. In other words, the body 20 defines an air guide channel that enables the airflow a1 to flow as illustrated in FIG. 3.

The outline of the regulation member 26 is approximately a partially-clipped shape from a cylinder. In other words, the outline of the regulation member 26 is approximately a pillar shape whose top and bottom surface have a shape formed from a sector (circular sector) by removing an isosceles triangle, which is formed with a chord segment of the sector and two line segments (radius), from the sector. The shape of the regulation member 26 will be described in detail below.

The airflow a2 changes its flow direction to flow to the center of the air outlet 25 (i.e., the collecting region) as same as the airflow a1, except for a difference between the left direction (L) and the right direction (R). The airflow a2 flows to a direction slightly leaned toward the front direction (F) compared with a direction perpendicular to the central axis AX. In other words, the body 20 defines an air guide channel that enables the airflow a2 to flow as illustrated in FIG. 3.

When the airflow a3 flows into the body 20, the airflow a3 once changes its flow direction to the upward direction (U) to be directed away from the central axis AX of the body 20, and then changes its flow direction to be directed close to the central axis AX again. After that, the airflow a3 flows to the center of the air outlet 25 (i.e., the collecting region) through the outlet 27 located upside of the center of the air outlet 25. The airflow a3 flows to a direction slightly leaned toward the front direction (F) compared with a direction perpendicular to the central axis AX. In other words, the body 20 defines an air guide channel that enables the airflow a3 to flow as illustrated in FIG. 3.

The airflow a4 changes its flow direction to flow to the center of the air outlet 25 (i.e., the collecting region) through the outlet 28 located downside of the center of the air outlet 25 as same as the airflow a3, except for a difference between the upward direction (U) and the downward direction (D). The airflow a4 flows to a direction slightly leaned toward the front direction (F) compared with a direction perpendicular to the central axis AX. In other words, the body 20 defines an air guide channel that enables the airflow a4 to flow as illustrated in FIG. 3.

As described above, the airflows a1, a2, a3, a4 flow to the center of the air outlet 25 (i.e., the collecting region) via the air guide channels and then collide with each other. When colliding with each other, the airflows a1, a2, a3, a4 merges (mixes). After that, the merged airflow (i.e., the blowing air A) of the airflows a1, a2, a3, a4 is blown out to a direction determined depending on the strengths of the airflows a1, a2, a3, a4.

In this embodiment, the location (area) to allow the airflows to be collided with each other as described above is here in after referred to as “collision area”. This collision area will be described in detail below.

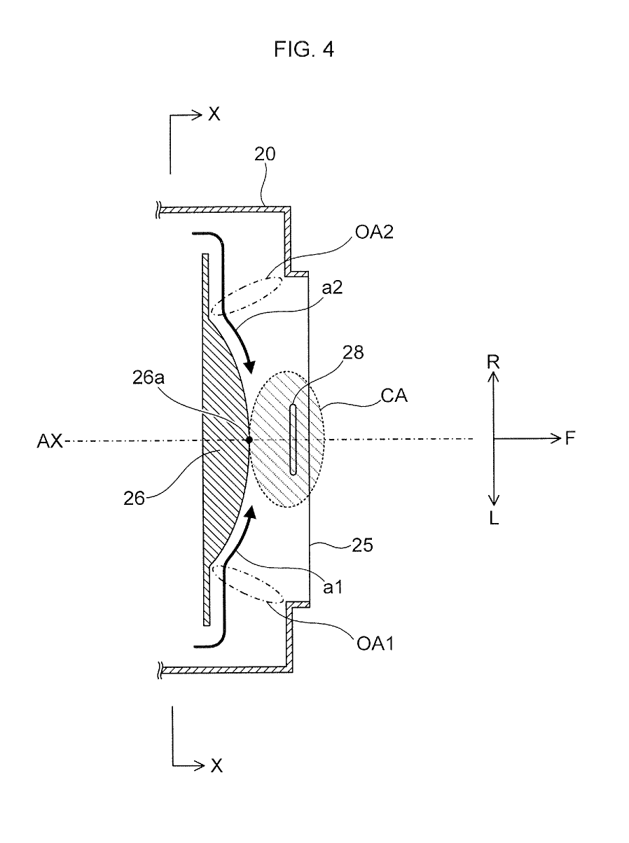

FIG. 4 is a schematic drawing illustrating a partial cross-section of the body 20 around the air outlet 25 when the body 20 is cut by using the X-X surface in FIG. 3 (i.e., a surface on which the front direction (F), the right direction (R) and the left direction (L) belongs). As illustrated in FIG. 4, the airflow a1 and the airflow a2 (and the airflows a3, a4 which are not illustrated) collide with each other in the collision area CA. The body 20 places the collision area CA at a position where at least part of the collision area CA is in a location upstream of the aperture surface of the air outlet 25 (i.e., in the air guide channels). As can be understood from the above, the location of the collision area CA can be set depending on parameters such as the structure of the air guide channels defined by the body 20 and the strengths of the airflows a1, a2, a3, a4.

The body 20 in this embodiment is configured to allow the airflows to flow into the collision area CA from four different directions.

In other words, the open ends of the air passages for the airflows a1, a2, a3, a4 near the air outlet 25 (in the figure, the open end OA1 for the airflow a1, the open end OA2 for the airflow a2, the outlet 27 for the airflow a3 which is not illustrated, and the outlet 28 for the airflow a4) open toward the collecting region so that at least part of the collision area CA, where the airflows through the open ends collide with each other, is in the air guide channels.

As described above, the regulation member 26 has a convex shape protruded to the front direction (F). In other words, the regulation member 26 has a convex shape protruded to the collision area CA, as illustrated in FIG. 4. Furthermore, in this embodiment, the front edge 26a touches to the collision area CA. The front edge 26a does not necessarily touches to the collision area CA and can separate from the collision area CA.

The body 20 of the apparatus embodiment 10 arranges the flow directions of the airflows a1, a2 on a substantially same plane. On the other hand, the body 20 also arranges the flow directions of the airflows a3, a4 on another substantially same plane (which is different from the plane where the flow directions of the airflows a1, a2 are arranged). In other words, the flow directions of the airflows a1, a2, a3, a4 are arranged so that not all of the flow directions are arranged on a substantially same plane.

Schematic configuration of the apparatus embodiment 10 is described above.

### (Actual Operation)

Actual operations of the apparatus embodiment 10 will be described below.

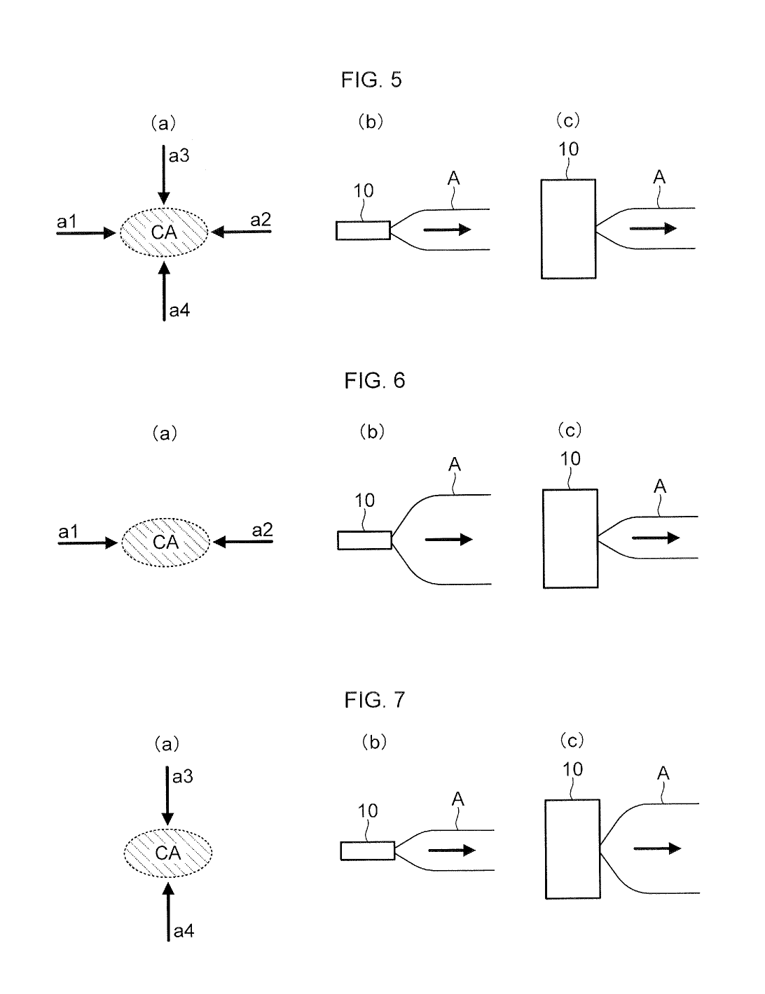

The apparatus embodiment 10 controls the strengths of the airflow a1, a2, a3, a4, which are guided to the collision area CA through the air guide channels, by changing opening degrees of the control valves 31, 32, 33, 34. The apparatus embodiment 10 thereby controls the flow direction and the convergence degree of the blowing air A. Several examples of controlling the blowing air A by the apparatus embodiment 10 will be described below by referring to FIG. 5 to FIG. 19.

FIG. 5 is a schematic drawing illustrating the flow direction and the convergence degree of the blowing air A when four airflows (i.e., the airflows a1, a2, a3, a4) flow into the collision area CA from four different directions. In particular, FIG. 5(a) is a schematic drawing, viewed from the front direction (F) in FIG. 3, illustrating the airflows flowing to the collision area CA. FIG. 5(b) is a schematic drawing, viewed from the left direction (L) in FIG. 3, illustrating a state of the blowing air A. FIG. 5(c) is a schematic drawing, viewed from the upward direction (U) in FIG. 3, illustrating a state of the blowing air A.

This example illustrated in FIG. 5 assumes, for the sake of simplicity, that the airflows a1, a2, a3, a4 have the same strength (the following examples illustrated in FIGS. 6-19 also assume the airflows have the same strength). However, the airflows a1, a2, a3, a4 does not necessarily have the same strength. The strengths of the airflows may be each controlled appropriately based on the flow direction and the convergence degree of the blowing air A.

As illustrated in FIG. 5(a)-(c), the blowing air A is blown out to the front direction (F) in a relatively converged state. Reasons for this include a reduction in a diffusion of the blowing air A in the upward direction (U) or the downward direction (D), which diffusion is caused by a collision of the airflow a1 from the left direction (L) and the airflow a2 from the right direction (R), due to the airflow a3 from the upward direction (U) and the airflow a4 from the downward direction (D).

In the following FIG. 6 to FIG. 19, the figures with the symbol (a) are schematic drawing, viewed from the front direction (F) in FIG. 3, illustrating the airflows flowing to the collision area CA, as same as FIG. 5. Furthermore, the figures with the symbol (b) are schematic drawings, viewed from the left direction (L) in FIG. 3, illustrating a state of the blowing air A, as same as FIG. 5. Furthermore, the figures with the symbol (c) are schematic drawings, viewed from the upward direction (U) in FIG. 3, illustrating a state of the blowing air A, as same as FIG. 5. In the following description regarding FIG. 6 to FIG. 19, any information about the subjects illustrated in the figures with the symbol (a)-(c) may be appropriately omitted.

FIG. 6 is a schematic drawing illustrating the state of the blowing air A when only two airflows, the airflows a1 from the left direction (L) and the airflow a2 from the right direction (R), flow into the collision area CA. In other words, this example does not include the airflow a3 and the airflow a4. In this example illustrated in FIG. 6, the airflows a1, a2 have the same strength.

The blowing air A in this example is blown out to the front direction (F) in a state that its diffusion in the upward direction (U) and the downward direction (D) is higher than that of the example in FIG. 5. Reasons for this include a lack of the reduction in the diffusion of the blowing air A in the upward and the downward direction (U, D) by the airflows a3, a4, as different from the example in FIG. 5.

This example does not include the airflow a3 and the airflow a4 (i.e., the strengths of the airflows are zero) for the same of simplicity. However, as can be understood from the above, the state of the blowing air A would have the same tendency as this example if the strengths of the airflows a3, a4 are smaller than those in the example illustrated in FIG. 5, while this example does not include the airflows a3, a4. In other words, controlling the strengths of the airflows a3, a4 enables the blowing air A to be any intermediate state between the example in FIG. 5 and the example in FIG. 6.

Furthermore, as can be understood from the above, in the examples illustrated in FIG. 7 to FIG. 19, controlling the strengths of the airflows enables the blowing air A to be any intermediate state between the state in the example that includes the airflows (i.e., the example in FIG. 5) and the state in the example that does not include the airflows, as same as this example.

FIG. 7 is a schematic drawing illustrating the state of the blowing air A when only two airflows, the airflows a3 from the upward direction (U) and the airflow a4 from the downward direction (D), flow into the collision area CA. In other words, this example does not include the airflow a1 and the airflow a2. In this example illustrated in FIG. 7, the airflows a3, a4 have the same strength.

The blowing air A in this example is blown out to the front direction (F) in a state that its diffusion in the right direction (R) and the left direction (L) is higher than that of the example in FIG. 5. Reasons for this include a lack of the reduction in the diffusion of the blowing air A in the left and the right direction (L, R) by the airflows a1, a2, as different from the example in FIG. 5.

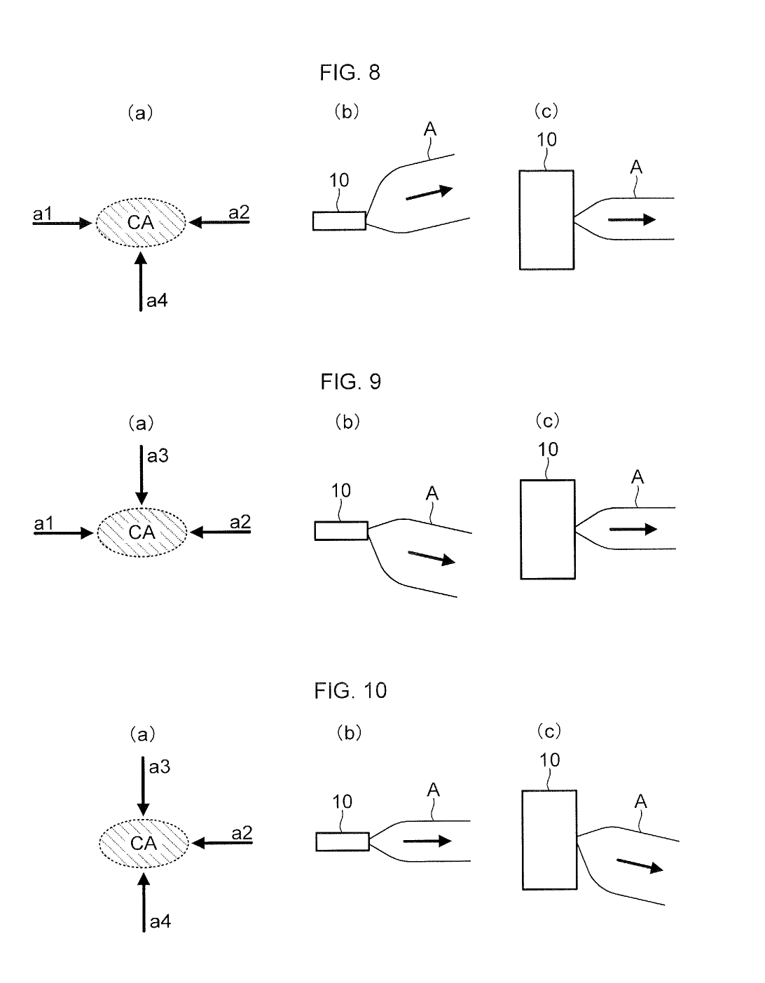

FIG. 8 is a schematic drawing illustrating the state of the blowing air A when only three airflows, the airflows a1 from the left direction (L), the airflow a2 from the right direction (R) and the airflow a4 from the downward direction (D), flow into the collision area CA. In other words, this example does not include the airflow a3. In this example illustrated in FIG. 8, the airflows a1, a2, a4 have the same strength.

The blowing air A in this example is blown out to a leaned direction to the upward direction (U) with respect to the front direction (F) in a state that its diffusion in the upward direction (U) is higher than that of the example in FIG. 5. Reasons for this include a lack of the reduction in the diffusion of the blowing air A in the upward direction (U) by the airflow a3, as different from the example in FIG. 5.

FIG. 9 is a schematic drawing illustrating the state of the blowing air A when only three airflows, the airflows a1 from the left direction (L), the airflow a2 from the right direction (R) and the airflow a3 from the upward direction (U), flow into the collision area CA. In other words, this example does not include the airflow a4. In this example illustrated in FIG. 9, the airflows a1, a2, a3 have the same strength.

The blowing air A in this example is blown out to a leaned direction to the downward direction (D) with respect to the front direction (F) in a state that its diffusion in the downward direction (D) is higher than that of the example in FIG. 5. Reasons for this include a lack of the reduction in the diffusion of the blowing air A in the downward direction (D) by the airflow a4, as different from the example in FIG. 5.

FIG. 10 is a schematic drawing illustrating the state of the blowing air A when only three airflows, the airflow a2 from the right direction (R), the airflow a3 from the upward direction (U) and the airflow a4 from the left direction (L), flow into the collision area CA. In other words, this example does not include the airflow a1. In this example illustrated in FIG. 10, the airflows a2, a3, a4 have the same strength.

The blowing air A in this example is blown out to a leaned direction to the left direction (L) with respect to the front direction (F) in a state that its diffusion in the left direction (L) is higher than that of the example in FIG. 5. Reasons for this include a lack of the reduction in the diffusion of the blowing air A in the left direction (L) by the airflow a1, as different from the example in FIG. 5.

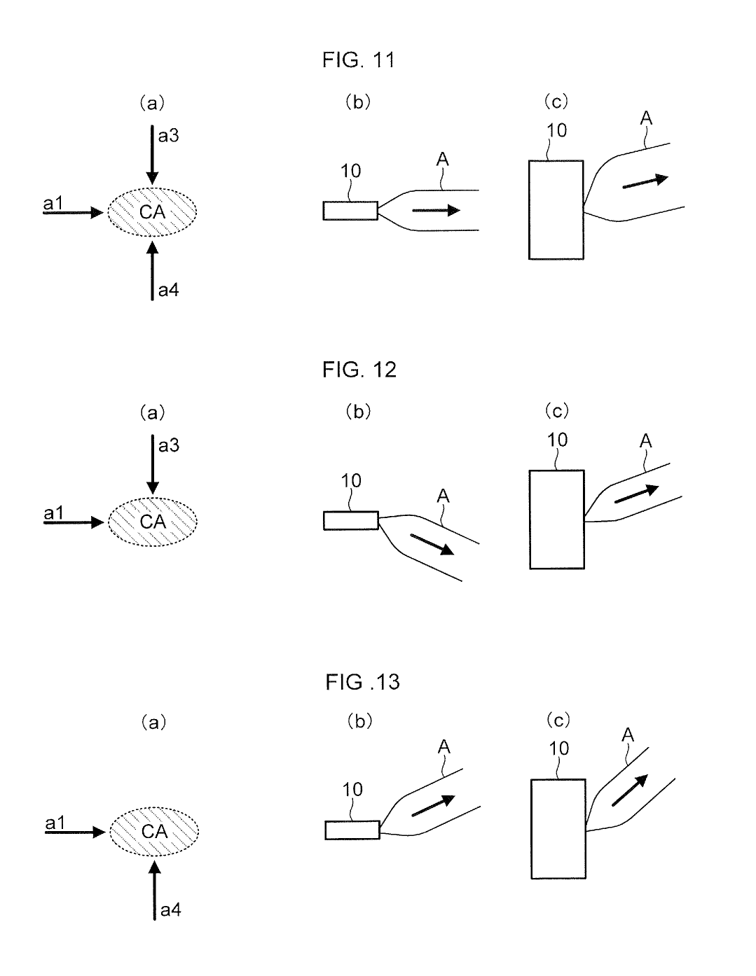

FIG. 11 is a schematic drawing illustrating the state of the blowing air A when only three airflows, the airflow a1 from the left direction (L), the airflow a3 from the upward direction (U) and the airflow a4 from the left direction (L), flow into the collision area CA. In other words, this example does not include the airflow a2. In this example illustrated in FIG. 11, the airflows a1, a3, a4 have the same strength.

The blowing air A in this example is blown out to a leaned direction to the right direction (R) with respect to the front direction (F) in a state that its diffusion in the right direction (R) is higher than that of the example in FIG. 5. Reasons for this include a lack of the reduction in the diffusion of the blowing air A in the right direction (R) by the airflow a2, as different from the example in FIG. 5.

FIG. 12 is a schematic drawing illustrating the state of the blowing air A when only two airflows, the airflows a1 from the left direction (L) and the airflow a3 from the upward direction (U), flow into the collision area CA. In other words, this example does not include the airflow a2 and the airflow a4. In this example illustrated in FIG. 12, the airflows a1, a3 have the same strength.

The blowing air A in this example is blown out to a leaned direction to the downward-right direction (D, R) with respect to the front direction (F) in a state that its diffusion is as same as that of the example in FIG. 5. Reasons for this include a low diffusion of the blowing air A compared with a diffusion in a front collision of airflows (see FIG. 6 and FIG. 7), while a lack of the reduction in the diffusion of the blowing air A as the example in FIG. 5.

FIG. 13 is a schematic drawing illustrating the state of the blowing air A when only two airflows, the airflows a1 from the left direction (L) and the airflow a4 from the downward direction (D), flow into the collision area CA. In other words, this example does not include the airflow a2 and the airflow a3. In this example illustrated in FIG. 13, the airflows a1, a4 have the same strength.

The blowing air A in this example is blown out to a leaned direction to the upward-right direction (U, R) with respect to the front direction (F) in a state that its diffusion is as same as that of the example in FIG. 5. Reasons for this include the same one in the example illustrated in FIG. 12.

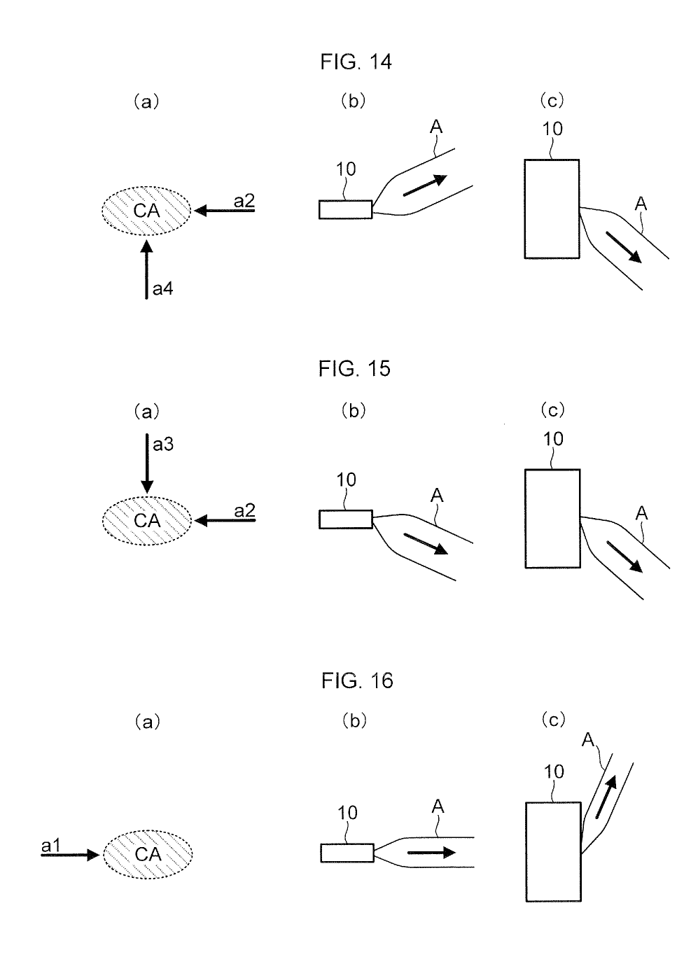

FIG. 14 is a schematic drawing illustrating the state of the blowing air A when only two airflows, the airflows a2 from the right direction (R) and the airflow a4 from the downward direction (D), flow into the collision area CA. In other words, this example does not include the airflow a1 and the airflow a3. In this example illustrated in FIG. 14, the airflows a2, a4 have the same strength.

The blowing air A in this example is blown out to a leaned direction to the upward-left direction (U, L) with respect to the front direction (F) in a state that its diffusion is as same as that of the example in FIG. 5. Reasons for this include the same one in the example illustrated in FIG. 12.

FIG. 15 is a schematic drawing illustrating the state of the blowing air A when only two airflows, the airflows a2 from the right direction (R) and the airflow a3 from the upward direction (U), flow into the collision area CA. In other words, this example does not include the airflow a1 and the airflow a4. In this example illustrated in FIG. 15, the airflows a2, a3 have the same strength.

The blowing air A in this example is blown out to a leaned direction to the downward-left direction (D, L) with respect to the front direction (F) in a state that its diffusion is as same as that of the example in FIG. 5. Reasons for this include the same one in the example illustrated in FIG. 12.

FIG. 16 is a schematic drawing illustrating the state of the blowing air A when only one airflows, the airflows a1 from the left direction (L), flow into the collision area CA. In other words, this example does not include the airflow a2, the airflow a3 and the airflow a4.

The blowing air A in this example is blown out to a leaned direction to the right direction (R) with respect to the front direction (F) in a state that its convergence is higher than that of the example in FIG. 5. Reasons for this include a small diffusion of the blowing air A due to the lack of the collision and the mergence of a plurality of airflows as the example in FIG. 5.

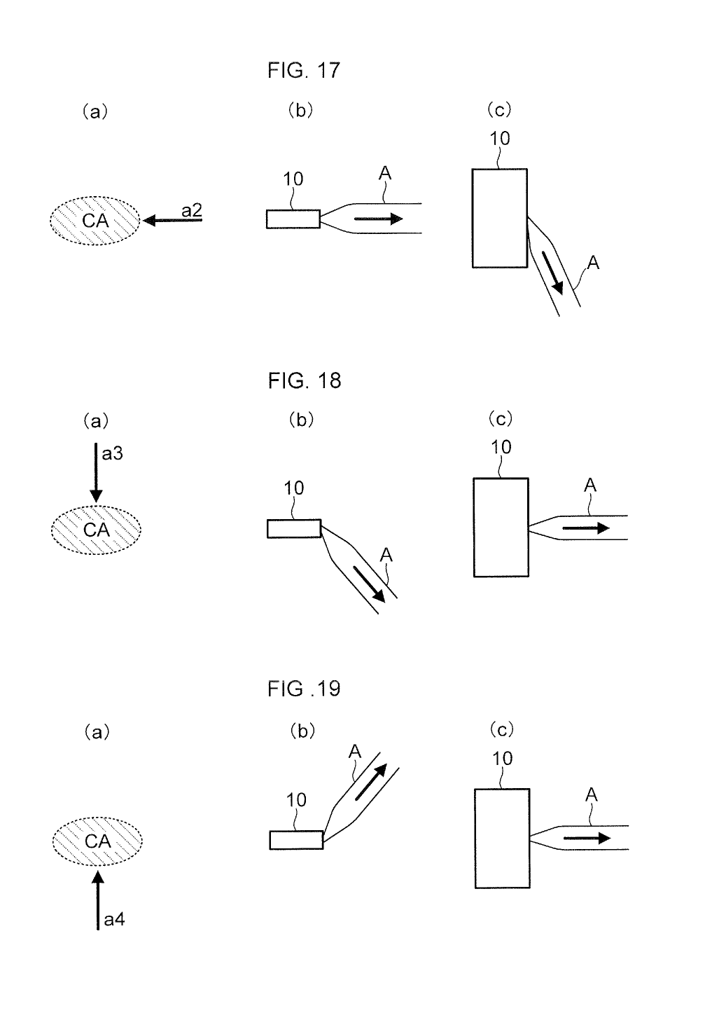

FIG. 17 is a schematic drawing illustrating the state of the blowing air A when only one airflows, the airflows a2 from the right direction (R), flow into the collision area CA. In other words, this example does not include the airflow a1, the airflow a3 and the airflow a4.

The blowing air A in this example is blown out to a leaned direction to the left direction (L) with respect to the front direction (F) in a state that its convergence is higher than that of the example in FIG. 5. Reasons for this include the same one in the example illustrated in FIG. 16.

FIG. 18 is a schematic drawing illustrating the state of the blowing air A when only one airflows, the airflows a3 from the upward direction (U), flow into the collision area CA. In other words, this example does not include the airflow a1, the airflow a2 and the airflow a4.

The blowing air A in this example is blown out to a leaned direction to the downward direction (D) with respect to the front direction (F) in a state that its convergence is higher than that of the example in FIG. 5. Reasons for this include the same one in the example illustrated in FIG. 16.

FIG. 19 is a schematic drawing illustrating the state of the blowing air A when only one airflows, the airflows a4 from the downward direction (D), flow into the collision area CA. In other words, this example does not include the airflow a1, the airflow a2 and the airflow a3.

The blowing air A in this example is blown out to a leaned direction to the upward direction (U) with respect to the front direction (F) in a state that its convergence is higher than that of the example in FIG. 5. Reasons for this include the same one in the example illustrated in FIG. 16.

The examples illustrated in FIG. 5 to FIG. 19 assumes, for the sake of simplicity, that the airflows a1, a2, a3, a4 have the same strength. However, the airflows a1, a2, a3, a4 does not necessarily have the same strength and may have different strengths. As can be understood from the above, the different strengths of the airflows a1, a2, a3, a4 enable the blowing air A blown out from the air outlet 25 to have any flow direction and any convergence degree depending on their strengths.

In other words, the strengths of the airflows a1, a2, a3, a4 may be controlled appropriately to align the flow direction and the convergence degree of the blowing air A with a target flow direction and convergence degree. In controlling the strengths of the airflows a1, a2, a3, a4, the strengths may be controlled individually (in other words, one of the strengths may be controlled with no relation to the others of the strengths), or the strengths may be controlled with any relations between at least two of them (in other words, one of the strengths may be controlled with any relations to at least one of the others of the strengths).

In particular, the opening degrees of the control valves 31, 32, 33, 34 (which correspond to the strengths of the airflows a1, a2, a3, a4, as described above) may be controlled appropriately to align the flow direction and the convergence degree of the blowing air A with a target flow direction and convergence degree.

As explained above, the apparatus embodiment 10 is configured to allow a plurality of (one to four) airflows to be guided to the collision area CA. Furthermore, the apparatus embodiment 10 is configured to enable the blowing air A to have any flow direction and any convergence degree by controlling the strengths of the airflows guided to the collision area CA. Thus, the apparatus embodiment 10 achieves any blowing air A having any flow direction and any convergence degree without using any members such as the air guide plates. Consequently, the apparatus embodiment 10 is an air outlet apparatus that enables reducing its size without limiting its own function(s).

### Overview of Embodiments

As explained by referring to FIGS. 1-19, an air outlet apparatus according to an embodiment of the present invention (the apparatus embodiment 10) defines: an air guide channel (i.e., the inside of the body 20) to pass through an airflow; and an air outlet 25 to blow out the airflow passed through the air guide channel.

The apparatus embodiment 10 has a configuration:

to guide a plurality of the airflows a1, a2, a3, a4 from a plurality of directions (L, R, U, D) toward a collision area CA, which is an area to allow the airflows a1, a2, a3, a4 to be collided with each other and at least part of which is in the air guide channel (i.e., the area upstream of the aperture surface of the air outlet 25); and

to control an blowing air A from the air outlet 25 through the air guide channel in at least one of flow direction or convergence degree by controlling strengths of the airflows guided to the collision area (i.e., the opening degrees of the control valves 31, 32, 33, 34).

The apparatus embodiment 10 has a regulation member 26 to regulate flow directions of the airflows guided to the collision area CA.

In the apparatus embodiment 10,

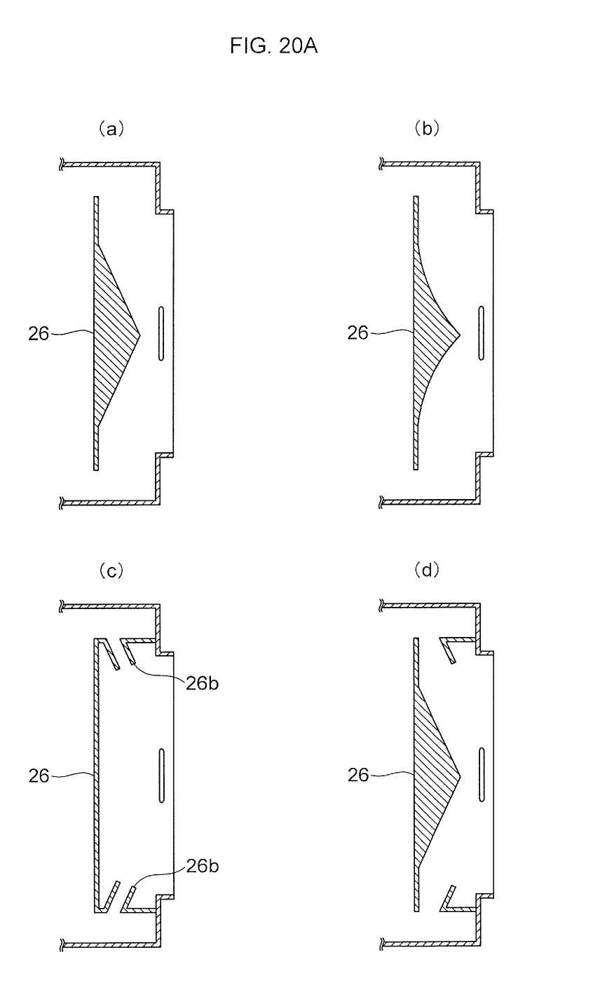

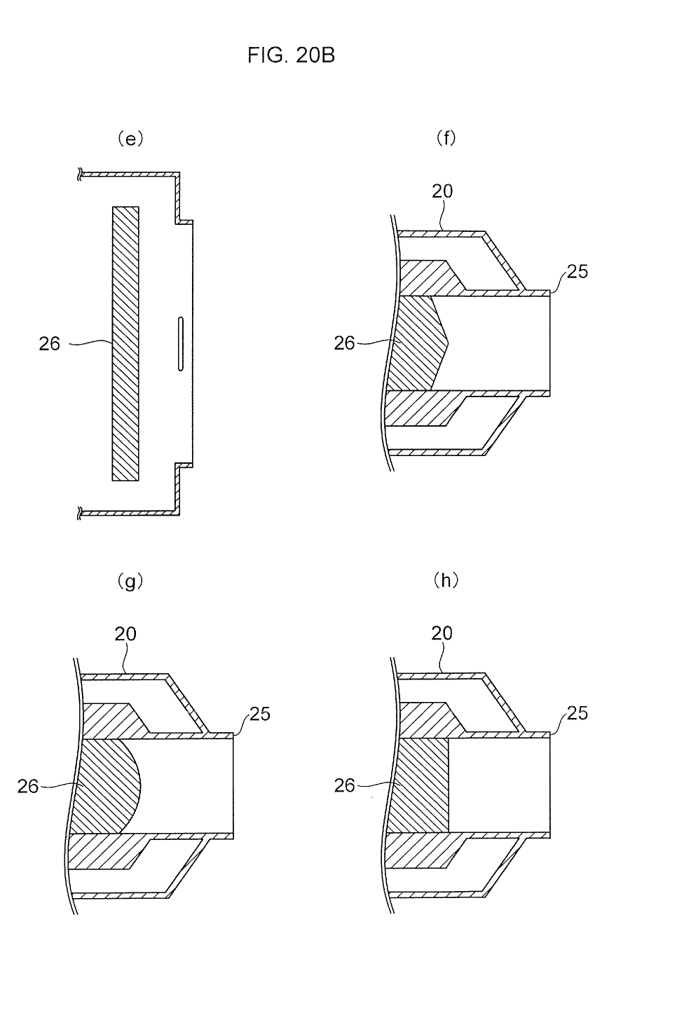

the regulation member 26 is a member having a convex shape protruded to the collision area CA. The regulation member 26 may be a member having a shape to allow the airflows guided to the collision area to be converged (see the tubular member 26b in FIG. 20A (c)), as described below.

The apparatus embodiment 10 has a configuration to allow the airflows to be guided toward the collision area CA from four directions (L, R, U, D) whose all or a part are arranged on separate planes different from each other (see FIG. 3. L and R are arranged on the same plane, while U and D are arranged on a plane different from the plane on which L and R are arranged).

Furthermore, the air outlet apparatus according to the present invention may have a configuration to allow the airflows to be guided toward the collision area CA from at least three directions whose all or a part are arranged on separate planes different from each other.

The apparatus embodiment 10 has valves (i.e., the control valves 31, 32, 33, 34) in the air guide channel to control an amount of the airflow passed through the air guide channel, and control the strength of the airflow a1, a2, a3, a4 guided to the collision area CA after passing through the air guide channel by changing an opening degree of the valves 31, 32, 33, 34.

In other words, the apparatus embodiment 10 has a body 20 including: an air guide channel (i.e., the inside of the body 20) having a plurality of air passages (i.e., the air passages to pass through the airflows a1, a2, a3, a4) and a collecting region (i.e., the area in the air guide channel near the center of the air outlet 25) to collect the air passages; an air outlet 25 to blow out air passed through the air guide channel; and air inlets 21-24 to allow air to flow into the air guide channel.

The air passages each has a first open end OA1, OA2, 27, 28 near the air outlet and a second open end 21-24 near the air inlet.

The first open ends each opens toward a collision area CA to locate at least part of the collision area CA in the air guide channel (i.e., the area upstream of the aperture surface of the air outlet 25), which is an area to allow airflows a1-a4 ejected from the first open ends to be collided with each other.

The air passages each has a control member (i.e., the control valves 31-34) to control a strength of the airflow to be guided to the collision area CA.

### Other Embodiments

While the present invention has been described in detail by referring to the specific embodiment, it is apparent that various modifications or corrections may be made by the person skilled in the art without departing from the spirit and the scope of the invention.

For example, the regulation member 26 of the apparatus embodiment 10 has approximately a partially-clipped convex shape from a cylinder (see FIG. 4). However, an air outlet apparatus according to the present invention may employ, as the regulation member 26, other embodiments. For example, several embodiments having the shapes and the configurations illustrated in FIG. 20A and FIG. 20B (in particular, the symbols (a) to (h) in the figures) may be employed as the regulation member 26. FIG. 20A and FIG. 20B illustrate a series of embodiments of the regulation member 26, and thus include a series of symbols (a) to (h).

In particular, FIG. 20A (a)-(d) and FIG. 20B (e) are schematic drawings illustrating partial cross-sections of the body 20 around the air outlet 25 when the body 20 is cut by using the X-X surface in FIG. 3. In other words, FIG. 20A (a)-(d) and FIG. 20B (e) illustrate cross-sections of the regulation member 26 viewed from the upward direction or the downward direction of the body 20. The regulation member 26 in FIG. 20A (a) has a triangle pole shape. The regulation member 26 in FIG. 20A (b) has a triangle-pole-like shape with two concave side surfaces. The regulation member 26 in FIG. 20A (c) has tubular members 26b to allow airflows to be ejected to target directions. Furthermore, the regulation member 26 in FIG. 20A (d) has a combined shape of the triangle pole shape in FIG. 20A (a) and the tubular shape in FIG. 20A (c). Additionally, as illustrated in FIG. 20B (e), an air outlet apparatus according to the present invention does not necessarily has a regulation member having a convex shape protruded to the collision area CA.

Furthermore, FIG. 20B (f)-(h) are schematic drawings illustrating partial cross-sections of the body 20 around the air outlet 25 when the body 20 is cut by using the Y-Y surface in FIG. 3. In other words, FIG. 20B (f)-(h) illustrate cross-sections of the regulation member 26 viewed from the right direction or the left direction of the body 20. The regulation member 26 in FIG. 20B (f) has a convex shape protruded to the collision area CA with a combination of two flat surface. The regulation member 26 in FIG. 20B (g) has a convex shape protruded to the collision area CA with a curved surface. Furthermore, the regulation member 26 in FIG. 20B (h) has a shape that does not protruded to the collision area CA. FIG. 20B (h) corresponds to the shape of the regulation member 26 employed in the above apparatus embodiment 10.

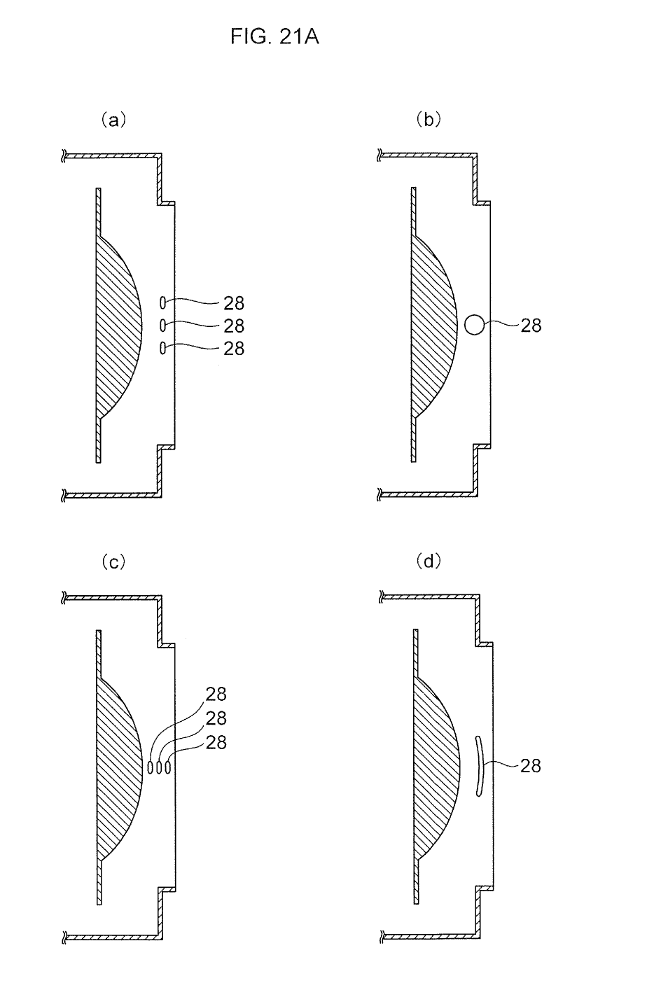

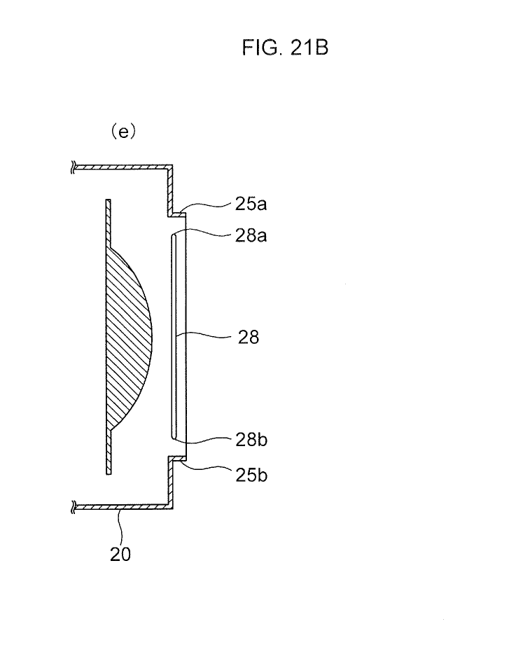

Furthermore, the outlets 27, 28 of the apparatus embodiment 10, which allow the airflows a3, a4 from the upward-downward directions to pass through their inside toward the collision area CA, has approximately a rectangle-like shape that is longer in the left-right direction than in the direction along the central axis AX. However, an air outlet apparatus according to the present invention may employ, as the outlet 27, 28, other embodiments. For example, several embodiments having the shapes and the configurations illustrated in FIG. 21A and FIG. 21B (in particular, the symbols (a) to (e) in the figures) may be employed as the outlet 27, 28.

In particular, FIG. 20A (a)-(d) and FIG. 20B (e) are schematic drawings illustrating partial cross-sections of the body 20 around the air outlet 25 when the body 20 is cut by using the X-X surface in FIG. 3. The outlet 28 in FIG. 21A (a) is configured by a plurality of outlets arranged in the right-left direction. The outlet 28 in FIG. 21A (b) has a circle shape. The outlet 28 in FIG. 21A (c) is configured by a plurality of outlets arranged in the direction along the central axis AX. The outlet 28 in FIG. 21A (d) has a shape curved along the shape of the regulation member 26. Furthermore, the outlet 28 in FIG. 21B (e) has a shape whose both ends 28a, 28b in the right-left direction close to both ends 25a, 25b of the air outlet 25 in the right-left direction (in other words, whose length in the right-left direction is substantially the same as that of the air outlet 25 in the right-left direction). Additionally, not only the outlet 28 but also outlet 27 may have the above shapes and configurations.

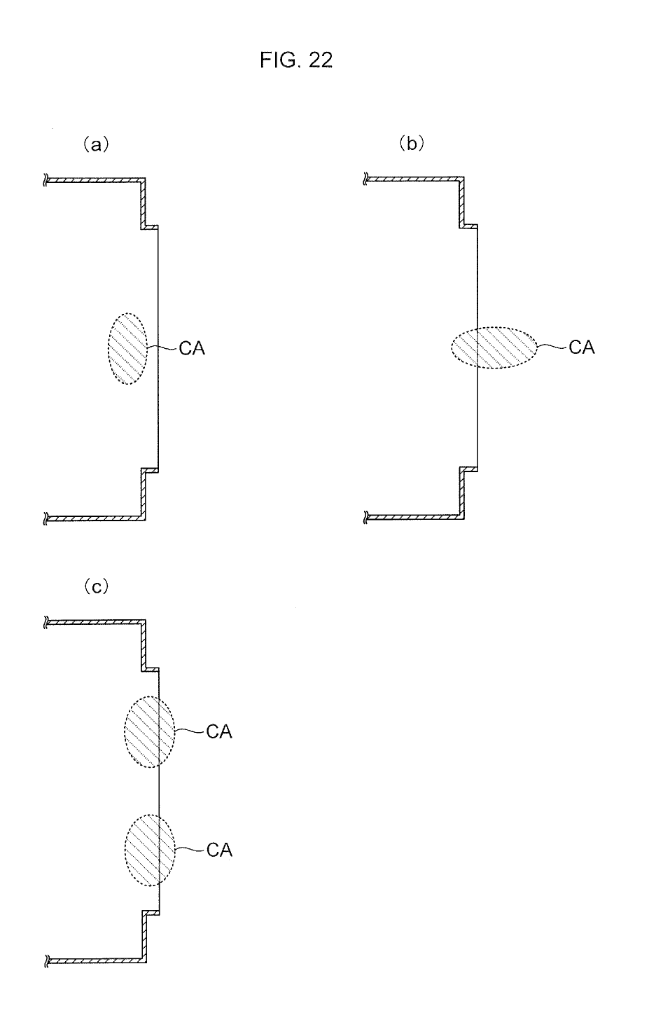

In addition, the collision area CA of the apparatus embodiment 10 is placed at a position where its part is in the air guide channels (see FIG. 4). However, an air outlet apparatus according to the present invention may employ, as the collision area CA, other embodiments. For example, several embodiments having the shapes and the configurations illustrated in FIG. 22 (a)-(c).

In particular, FIG. 22 (a)-(c) are schematic drawings illustrating partial cross-sections of the body 20 around the air outlet 25 when the body 20 is cut by using the X-X surface in FIG. 3. The collision area CA in FIG. 22 (a) is placed at a position where its whole area is in the air guide channels. The collision area CA in FIG. 22 (b) has an ellipse shape extended to the front direction (F) of the air outlet apparatus. Furthermore, the collision area CA in FIG. 22 (c) includes a plurality of (two in this example) collision areas CA. A plurality of collision areas CA illustrated in FIG. 22 (c) may be formed when the airflows a3, a4 from the upward-downward direction (U, D) have platy shapes spreading in the right-left direction (R, L).

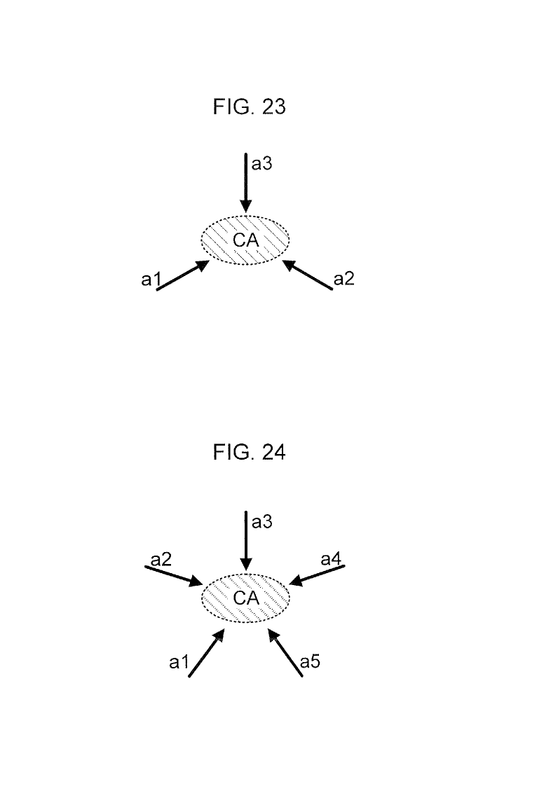

Furthermore, the apparatus embodiment 10 allows four airflows a1, a2, a3, a4 to be flowed toward the collision area CA from four directions. However, an air outlet apparatus according to the present invention may be configured to allow three airflows to be flowed toward the collision area CA from three directions (where all or a part of the three directions are arranged on separate planes that are different from each other, see FIG. 23), or to allow five or more airflows to be flowed toward the collision area CA from five or more directions (see FIG. 24).

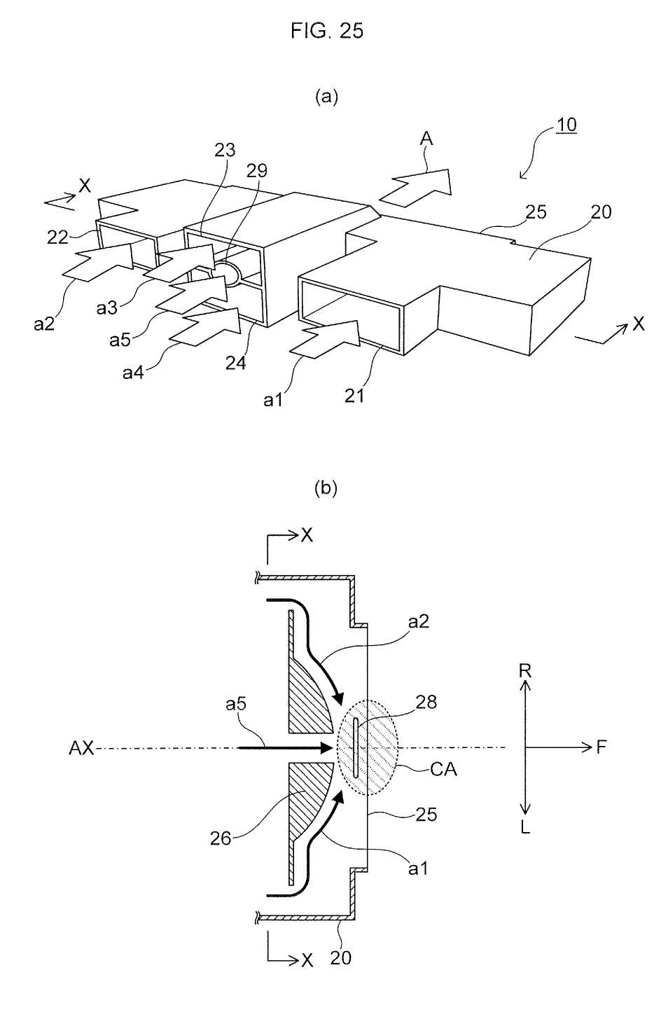

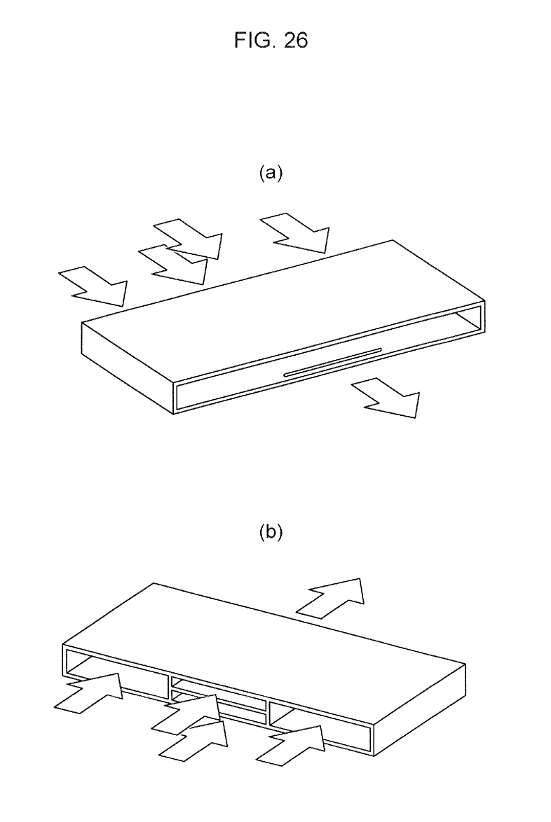

For example, as an example of an air outlet apparatus that allows to five airflows to be flowed toward the collision area CA from five directions, FIG. 25 (a) is a schematic perspective drawing illustrating an air outlet apparatus for this example viewed from its back. FIG. 25 (b) is a schematic drawing illustrating partial cross-sections of the body 20 around the air outlet 25 when this air outlet apparatus is cut by using the X-X surface in FIG. 25 (a) (which corresponds to the X-X surface in FIG. 3).

As illustrated in FIG. 25 (a), this air outlet apparatus has additional air passage to allow an airflow a5 to pass through the passage in addition to the air passages for the airflows a1, a2, a3, a4 of the apparatus embodiment 10. In other words, this air outlet apparatus has additional air inlet 29 in addition to the air inlets 21, 22, 23, 24. In FIG. 25 (a), the control valves located at the air passages are omitted for the sake of simplicity.

This additional airflow a5 flows parallel to its central axis AX (in other words, to penetrate its body from the back direction to the front direction) as illustrated in FIG. 25 (b). The airflow a5 collides with the airflows a1, a2 and the airflows a3, a4 (not illustrated) at the collision area CA. In other words, the air outlet apparatus in this example allows to five airflows a1, a2, a3, a4, a5 to be flowed toward the collision area CA from five directions.

The air outlet apparatus illustrated in FIG. 25 (a), 25 (b) may achieve any blowing air A having any flow direction and any convergence degree in the front direction (F) by controlling the strength of the airflow a5 in addition to the strengths of the airflows a1, a2, a3, a4 (see FIGS. 5-19).

Furthermore, the body 20 of the apparatus embodiment 10 has the shape illustrated in FIGS. 1-3. However, an air outlet apparatus according to the present invention may employ more simple shape (for example, an appropriately cuboid shape illustrated in FIG. 26 (a) and FIG. 26 (b)). In FIGS. 26 (a), (b), the control valves located at the air passages are omitted for the sake of simplicity. Furthermore, an air outlet apparatus according to the present invention may employ tubular shapes such as a cylinder hollow shape or a polygonal pillar hollow shape. An air outlet apparatus having the cylinder hollow shape may employ, as the regulation member 26, cone-like members (such as a member having cone or pyramid shape) or hemisphere members. In addition, an air outlet apparatus not having the cylinder hollow shape may employ, as the regulation member 26, cone-like members or hemisphere members.

### INDUSTRIAL APPLICABILITY

As explained above, the present invention can be applied to an air outlet apparatus that enables reducing its size without limiting its own function(s).

### REFERENCE SIGNS LIST

10: Air outlet apparatus
20: Body
25: Air outlet
26: Regulation member
31, 32, 33, 34: Control valve
CA: Collision area
A: Blowing air

1-12. (canceled)

13. An air outlet apparatus comprising:
a body defining: an air guide channel to pass through an airflow; and an air outlet to blow out the airflow passed through the air guide channel; and
a valve in the air guide channel to control an amount of the airflow passed through the air guide channel,
the air outlet apparatus having a configuration:
to guide at least three of the airflows from at least three directions toward a collision area, the collision area being an area to allow the airflows to be collided with each other and at least part of the collision area being in the air guide channel, all or a part of the at least three directions being arranged on separate planes different from each other;
to allow at least part of the airflows guided toward the collision area to be further regulated by using a regulation member having a convex shape protruded from the body to the collision area along a central axis of the body,
to control an blowing air from the air outlet through the air guide channel in at least one of flow direction or convergence degree by changing opening degrees of the valves to control strengths of the airflows guided to the collision area.

14. The air outlet apparatus according to claim 13,
wherein the regulation member further includes a member having a shape to allow the airflows guided to the collision area to be converged.

15. The air outlet apparatus according to claim 13,
wherein the air outlet apparatus has a configuration to allow the airflows to be guided toward the collision area from four directions, and all or a part of the four directions are arranged on separate planes different from each other.

16. An air outlet apparatus comprising:
a body including: an air guide channel having a plurality of air passages and a collecting region to collect the air passages; an air outlet to blow out air passed through the air guide channel; and an air inlet to allow air to flow into the air guide channel; and
a valve in the air guide channel to control an amount of an airflow passed through the air guide channel,
the air passages each having a first open end near the air outlet and a second open end near the air inlet,
the first open ends each opening toward a collision area to locate at least part of the collision area in the air guide channel and to guide at least three of the airflows from at least three directions toward the collision area, the collision area being an area to allow the airflows ejected from the first open ends to be collided with each other, all or a part of the at least three directions being arranged on separate planes different from each other,
the air outlet apparatus further comprising a regulation member having a convex shape protruded from the body to the collision area along a central axis of the body to further regulate at least part of the airflows guided toward the collision area,
the valves controlling strengths of the airflows guided toward the collision area by changing opening degrees of the valves.

17. The air outlet apparatus according to claim 16,
wherein the regulation member further includes a member having a shape to allow the airflows guided to the collision area to be converged.

18. The air outlet apparatus according to claim 16,
wherein the first open ends each opens toward the collision area to allow the airflows to be ejected toward the collision area from four directions, and all or a part of the four directions are arranged on separate planes different from each other.

19. The air outlet apparatus according to claim 13,
wherein the regulation member is integrally formed with the body as part of the body.

20. The air outlet apparatus according to claim 13,
wherein the body is configured to have the central axis aligned with an axis passing through a center point of an aperture surface of the air outlet and perpendicular to the aperture surface.

21. The air outlet apparatus according to claim 13,
wherein the valve is configured to control the strength of the airflow guided toward the collision area while keeping the flow direction of the airflow.

22. The air outlet apparatus according to claim 13,
wherein the air outlet apparatus comprises no air guide plate to control the flow direction of the blowing air.

23. The air outlet apparatus according to claim 13,
wherein the air outlet apparatus has a cuboid-like shape.
